(19) United States
(12) Patent Application Publication
(10) Pub. No.: US 2018/0214246 A1
(43) Pub. Date: Aug. 2, 2018

(54) DENTAL INSTRUMENT COMPRISING A GEARING FOR DRIVING A TOOL

(71) Applicant: SIRONA DENTAL SYSTEMS GMBH, Bensheim (DE)

(72) Inventor: Metin ERTUGRUL, Rodermark (DE)

(73) Assignee: DENTSPLY SIRONA Inc., York, PA (US)

(21) Appl. No.: 15/532,526

(22) PCT Filed: Dec. 17, 2015
(86) PCT No.: PCT/EP2015/080339

§ 371 Date: Apr. 11, 2018

(30) Foreign Application Priority Data
Dec. 17, 2014 (DE) 102014226325.5

(51) Int. Cl. A61C 1/18

(52) U.S. Cl. CPC A61C 1/186

(57) ABSTRACT

The invention relates to a dental instrument, comprising a gearing for driving a tool, wherein at least one torque limiting device is provided, which can be brought into contact with the gearing, as a result of which the maximum acting torque in the gearing can be limited.

### TECHNICAL FIELD

The invention relates to a dental instrument comprising a gearing for driving a tool.

### PRIOR ART

In dental instruments having gearing stages, a torque limiter is very helpful for protecting gearing components, shafts, ball bearings in the drive train, as well as tools—for example, to protect endo files. In addition, it can happen—for example, during an endo treatment—that the endo files can break when a certain torque is exceeded and remain stuck in the root canal. The removal of these files is associated with a considerable time expenditure. Problems can also then occur, if, in the presence of hand or angle instruments, a drill or a milling cutter abruptly stops—for example, because it has jammed—because high torque loads occur in this case due to moments of inertia and short braking times. The resulting high demands on gears and tensioning systems within a gearing can lead to premature failure from an overload fracture.

A dental instrument having a first drive and a second output is known from EP 1 698 297 A1, wherein a clutch is provided between the first drive and the second output to transmit torque from the first drive to the second output, and a treatment tool is provided on the second output. The clutch is designed as a rheological clutch for transferring a torque from the first drive to the second output, which makes it possible to precisely control the torque.

In addition, a circuit arrangement is known from EP 0 729 221 A1 for controlling the speed of a miniature DC motor for driving dental tools, means for the brief interruption of the motor current and for the switching of the terminal voltage of the motor being provided in the motor circuit. The arrangement also includes a microcontroller that contains a regulator having a target/actual comparison in which the target values corresponding to a target speed are compared to actual values, in which measured values of a current and electromotive force measurement are additionally entered and processed, wherein the regulator is designed in such a way that it reacts to a drop in speed of the motor caused by rapid load increase and switches off the torque of the motor before it comes to a standstill, wherein a standstill of the tool is prevented by application of short pulses.

Furthermore, a hand instrument for medical purposes having a tool holder arranged on the front end of the hand instrument is described in DE 100 30 114 A1. The hand instrument has a first-hold clutch for loosely affixing a tool in the tool holder and a drive connection extending longitudinally through the hand instrument for a rotational and/or linear drive of the tool holder, wherein a device is provided for limiting a maximum torque value transmitted to the tool holder to a lower torque value, wherein the apparatus is optionally switchable off and back on via an adjusting device.

Also described in WO 2013/076102 A2 is a medical treatment device that has an apparatus for limiting a maximum torque value transmitted to the tool holder to a lower torque value.

Finally, a dental instrument having a driven tool is known from DE 100 61 900 A1, wherein a transmission device having at least one magnetic and/or magnetizable clutch element is provided and wherein means for influencing the torque of the magnetic and/or magnetizable clutch element is provided.

The aim of the present invention is to provide an instrument by which the torque of a gearing can very easily be adjusted or at least limited.

### DESCRIPTION OF THE INVENTION

The attainment of the aforementioned aim is based upon the features of claim 1. Advantageous embodiments of the invention are the subject matter of the dependent claims.

The dental instrument according to the invention has a gearing for driving a tool, wherein the gearing is arranged in a gearing housing. The gearing includes at least one gearing stage that contains a ring gear, wherein at least one torque-limiting device is arranged in the interior of the gearing housing. By means of the torque-limiting device, the torque of the gearing can be adjusted, and the maximum operating torque in the gearing can be limited.

The at least one ring gear is mounted loosely in relation to the gearing housing, and the torque-limiting device has a spring element under tension at least partially in contact with the ring gear and which brings it into contact with the gearing housing in order to change or at least limit the torque, wherein the ring gear is designed to limit torque with respect to the gearing housing against a pre-stress by means of slippage.

An advantage of this torque-limiting device is that it is simple and compactly built, and very robust. The torque-limiting device can, therefore, also be used at very high speeds. Because the torque-limiting device is located in the gearing housing, it is not very susceptible to malfunction. Because the torque-limiting device is very simple and compact, it can be easily expanded and replaced, as needed, by a new torque-limiting device. Such spring elements are very inexpensive and readily available. In addition, the work area can be set up very precisely. It is also advantageous that there are a variety of spring elements that can be used. For example, in addition to ondular springs, compression springs, or leaf springs, gas springs may also be used.

In a preferred embodiment, the gearing has a gearing stage, the gearing is an eccentric gearing, and the ring gear is part of the eccentric gearing. It is advantageous that the gearing has a very simple, yet robust design, because it has only one stage. In an additional preferred embodiment, the gearing contains two or more gearing stages and is designed as a planetary gearing. This planetary gearing has at least one slip ring gear. Each of the gearing stages includes at least one planetary gear, wherein this planetary gear is arranged between a sun gear and the ring gear, and wherein the ring gear can be brought into contact with the torque-limiting device. If the torque-limiting device is in contact with the ring gear, the torque is then limited. Preferably, each stage of the gearing has three planetary gears. The planetary gearing preferably contains one to three stages, wherein the planetary gearing especially preferably has two stages. Thus, the planetary gearing has a very compact design.

In a further advantageous embodiment, additional ring gears are provided that each have provided at least one gearing stage, wherein these additional ring gears are arranged fixedly in the gearing housing. Two or more gearing stages are preferably provided in these additional fixed ring gears. By providing additional ring gears, a much larger number of transmission ratios can be realized.

In one specific embodiment, each gearing stage has the same module. The module is between 0.1 mm and 0.7 mm, and preferably, between 0.15 mm and 0.3 mm, in an eccentric gear—preferably, between 0.2 and 0.5 mm. If the gearing stages have the same module, the embodiment is then very cost-effective.

In an additional advantageous embodiment, a second torque-limiting device is provided that is also arranged in the interior of the gearing housing, wherein the spring element can at least partially be brought into contact with an end opposite the first end of the ring gear. By providing a second torque-limiting device, the torque can be even more precisely adjusted. Because the usable spring travel is doubled by the provision of a second torque-limiting device, this variant with a second torque-limiting device is barely susceptible to malfunction.

In another preferred embodiment is provided a counter-holder, onto which the spring element of the torque-limiting device is attached in such a manner that the spring element is arranged between the end of the ring gear and the counter-holder. The counter-holder is thus firmly mounted in the gearing housing. It is, however, beneficial if the counter-holder can still be moved after mounting in the gearing housing, because it can thus be optimally arranged in the gearing and the spring force of the spring elements adjusted to the desired value before commissioning of the instrument. The counter-holder is next connected in a non-rotational and non-releasable manner to the gearing housing, so that its adjustment can no longer be changed. If the counter-holder is arranged fixedly in the gearing housing, this has the advantage that the torque is fixed from the outset. Manipulation from outside—for example, by adjusting the torque-limiting device during operation of dental instruments—is therefore not possible.

In another preferred embodiment, a counter-holder is again provided, to which the spring element of the torque-limiting device is attached. The spring element is arranged between the end of the ring gear and the counter-holder, wherein the counter-holder is arranged in the gearing housing. The counter-holder is part of an adjusting element by which the spring force of the spring element, and thus the torque, can be changed. This variant is advantageous in that the torque-limiting device can be adjusted, and the torque can be changed as needed via the adjusting element. The advantage in this is that the torque can also be readjusted or adjusted even during operation.

In particularly preferred embodiment, the adjusting element has a lever that is arranged outside of the transmission housing. This lever is connected to the counter-holder via a connecting means preferably designed as a pin. Because the lever is arranged outside the gearing housing and is therefore accessible for a user, the torque-limiting device can be adjusted by the user, and the torque can be changed at any time—even while the instrument is in operation. This is advantageous in that the user can comfortably reach the lever of the adjusting element without, for example, having to open the gearing housing in order to adjust the torque-limiting device.

The gearing housing preferably has a bore into which the connecting means that connects the lever to the counter-holder is inserted. Such a bore can be easily introduced into the gearing housing, thus affording an economical design.

In another preferred embodiment, the adjusting element has a thread that is in connection with an adjusting thread that is situated in a groove in the gear housing. Because such threads are very easy to manufacture, this is a cost-effective variant by which the torque-limiting device can be adjusted. In addition, the torque can be very precisely set using a thread of this sort. In another preferred embodiment, the at least one torque-limiting device in the dental instrument is connected to an adjusting element via the spring element, wherein the adjusting element sits at least partially in a circumferential groove. This groove is made on an outer side of the gearing housing. Because the adjusting element is at least partially arranged in the groove, the adjusting element is sufficiently rigidly affixed to the gearing housing that it is not liable to being inadvertently adjusted by vibrations, to which it is exposed during operation of the instrument. This ensures that torque can only be changed during operation if the user causes this by adjusting the adjusting element.

In an additional preferred embodiment of the dental instrument, the groove, in which the adjusting element is at least partially installed, connects to a radially extending bore. The spring element is arranged in this bore in such a manner that the spring element can be brought into contact with an outer surface of the ring gear. This embodiment is a further variant, by which the torque can easily be limited by means of the torque-limiting device.

The adjusting element is preferably a set screw, because a set screw is a simple and very inexpensive component.

In a particularly preferred embodiment, a washer is attached to the spring element, wherein the washer is arranged between the spring element and the ring gear. The ring gear thus comes into contact with the washer, and not with the spring element. This prevents the spring element from damaging the ring gear or the ring gear from damaging the spring element, which would be possible if the ring gear and the spring element were brought directly into contact with each other.

In another particularly preferred embodiment, at least one torque-limiting device is provided that can be brought into contact with the outer surface of the ring gear, and at least one additional torque-limiting device is provided that can be brought into contact with an end of the ring gear. The provision of these at least two torque-limiting devices allows the torque to be more precisely adjusted, because torque-limiting devices are provided at the ends of the ring gear, as well as on the outer surface of the ring gear.

### BRIEF DESCRIPTION OF THE DRAWINGS

Exemplary embodiments of the invention are illustrated in the drawings and explained in detail below. Shown are:

FIG. 1 inner workings of a part of a gearing;

FIG. 2 a schematic illustration of the part of the gearing illustrated in FIG. 1;

FIG. 3 a schematic illustration of a first variant of the part of the gearing illustrated in FIG. 2;

FIG. 4 a schematic illustration of a second variant of the part of the gearing illustrated in FIG. 2, and

FIG. 5 a schematic illustration of a third variant of the part of the gearing illustrated in FIG. 4.

### EXEMPLARY EMBODIMENTS

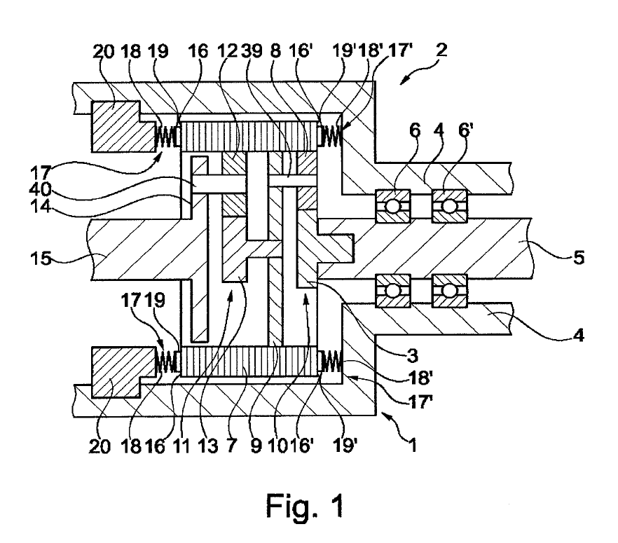

FIG. 1 shows an interior of a part of a gearing 1 of an instrument 2, wherein the gearing preferably is a lubricated gearing 1. Using gearing 1, a mounted tool (not shown) attached to instrument 2 can be set in motion. This instrument is a dental instrument, whereby the tool can, for example, be an endo file, a drill, or a milling cutter.

The gearing 1 is designed as a planetary gearing. This planetary gearing 1 is housed in a gearing housing 4 and has a first sun gear 3, which is affixed to a shaft 5, wherein the sun gear 3 is advantageously designed as one piece with shaft 5. Shaft 5 is introduced from outside into gearing housing 4 and is held in gearing housing 4 by retaining devices 6, 6′. The retaining devices are preferably ball bearings. The ring gear 7 is preferably arranged in gearing housing 4 as slip ring gear 7. Ring gear 7 sits loosely in gearing housing 4 and has a loose fit. Adjacent to first sun gear 3 is arranged a first planetary gear 8. This first planetary gear 8 is rotatably mounted on a first pin 39. Pin 39 is mounted so as to be rotationally fixed on a first web 9, wherein pin 39 can be pressed into web 9, and wherein the planetary gear or the planetary gears of planetary gearing 1 are rotatably mounted on first pin 39. Web 9, as well as pin 39, can also be one piece. First sun gear 3, as well as first planetary gear 8, are designed as gear wheels and are engaged with ring gear 7, which provides an internal toothing. Sun gear 3, as well as planetary gear 8 mounted on web 9, are thus surrounded by ring gear 7 and form a first stage 10 of planetary gearing 1. This first stage 10 has additional planetary gears that are, however, not visible because of the illustration of gearing 1 in FIG. 1. First stage 10 preferably has a total of three planetary gears, wherein it is conceivable to provide a single planetary gear, two, or even more than 3 planetary gears. These additional planetary gears are also each arranged between ring gear 7 and sun gear 3. Ceramic, steel, or even plastic, e.g., polyether ether ketone (PEEK), are suitable for these individual components of gearing 1. Because the design of a planetary gearing is known, a more detailed description is omitted.

A second stage 11 adjoins first stage 10. This second stage 11 is also located in ring gear 7 and includes additional planetary gears, wherein only the planetary gear 12 arranged between a second sun gear 13 and ring gear 7 is visible. Sun gear 13 is mounted so as to be rotationally fixed on web 9, and planetary gear 12 is rotatably mounted on a second pin 40. Second pin 40 is mounted so as to be rotationally fixed to second web 14. An additional shaft 15, by which a tool not shown in FIG. 1 can be driven, is arranged on second web 14. Second stage 11 also includes three planetary gears, wherein it is also possible to include more or fewer than three planetary gears. An advantage of this gearing 1 with two stages is that a high step-up or step-down ratio can be attained.

On one end 16 of ring gear 7, a torque-limiting device 17 is provided. This torque-limiting device 17 includes a spring element 18 and a washer 19, wherein spring element 18 is affixed to a counter-holder 20.

Although washer 19 can be omitted, this washer 19 has the advantage that ring gear 7 is in contact with washer 19, and not with spring element 18. This thereby prevents spring element 18 from damaging ring gear 7, or ring gear 7 from damaging spring element 18.

At one end 16′ opposite end 16 of ring gear 7 is arranged a second torque-limiting device 17′ that in turn contains a spring element 18′, as well as a washer 19′, the first torque-limiting device 17 and second torque-limiting device 17′ being of identical design. Ring gear 7, loosely arranged in gearing housing 4, is thus held by both torque-limiting devices 17 and 17′. Because torque-limiting devices 17, 17′ have spring elements 18, 18′, ring gear 7 is thus held by an axially-acting spring force. The spring force of both torque-limiting devices 17, 17′ is adjusted when mounting the torque-limiting devices 17, 17′ using a threaded ring that can be part of counter-holder 20, wherein the spring force of spring element 18 of torque-limiting device 17 is changeable, as needed, by the user via counter-holder 20, if counter-holder 20 is designed as an adjusting element. A threaded ring is not shown, for clarity's sake. In this variation, counter-holder 20 is, however, designed so that it is adjusted once initially, i.e., before commissioning of instrument 2. Counter-holder 20 is next connected in a non-rotational and non-releasable manner to gearing housing 4 so that it can no longer be adjusted.

As with torque-limiting device 17, washer 19′ can also be omitted in torque-limiting device 17′.

It is also possible that only one torque-limiting device is provided. In this case, torque-limiting device 17′ may be omitted, for example, so that ring gear 7, which is designed to slip, is held only by torque-limiting device 17. However, this is not shown in FIG. 1.

Planetary gearing 1 is a two-stage gearing, wherein both gearing stages 10, 11 have the same ring gear 7.

It is understood that planetary gearing 1 can also only have one stage. In this case, only stage 10 is housed in gearing housing 4. In a one-stage gearing, the gearing is preferably designed as an eccentric gearing, which is not shown in FIG. 1.

Generally speaking, planetary gearing 1 can thus be designed as an n-staged planetary gearing, where n is the number of stages and n=1, 2, 3, 4, . . . . Each of the n stages includes a sun gear as well as at least a planetary gear, wherein each of the n stages is arranged in the same ring gear. The at least one planetary gear is arranged in each case between the sun gear and the ring gear. It is understood that each stage can also include more than one planetary gear, wherein three planetary gears are advantageously provided per stage.

The advantage of a gearing having two or more stages is that this gearing not only represents a cost-effective variation, but also provides a gearing having a high step-down and step-up ratio.

In order to control or limit the torque of planetary gearing 1, torque-limiting device 17 is mounted on end 16 of ring gear 7. The torque-limiting device 17 can be a fixed or an adjustable torque-limiting device. If torque-limiting device 17 is a fixed torque-limiting device—as is the case according to FIG. 1—spring element 18 then has a defined pre-stress. With this defined pre-stress, torque-limiting device 17 is in contact with ring gear 7. Due to this spring force, the static friction is higher than the forces occurring during normal operation, such that ring gear 7 remains still. Using this fixed torque-limiting device 17, a desired torque can thus be set.

If torque-limiting device 17 is, by contrast, adjustable, this can be done via counter-holder 20, for example, which can be moved in the direction of ring gear 7 or moved away from ring gear 7 (not shown).

In this case, the spring force of spring element 18 is preferably adjusted using an adjusting element, by which the torque can also be changed.

Spring elements 18 and 18′ can also be designed as ondular springs. Instead of ondular springs, however, another type of spring can be used—for example, a leaf spring, a compression spring, or a gas spring.

The torque also changes depending upon how firmly torque-limiting device 17 is pressed against ring gear 7 by counter-holder 20. For a person skilled in the art, it is clear that ring gear 7 is thus fixed in gearing housing 4 as a function of the torque.

It is also possible that, instead of both torque-limiting devices 17, 17′, an adjustable brace could be substituted for each as a torque-limiting device. The first brace thus surrounds end 16, and the second brace surrounds end 16′ of ring gear 7, so that ring gear 7 is held in gearing housing 4 by both braces. Because the braces are adjustable, the operational maximum acting torque can thus be limited by the braces.

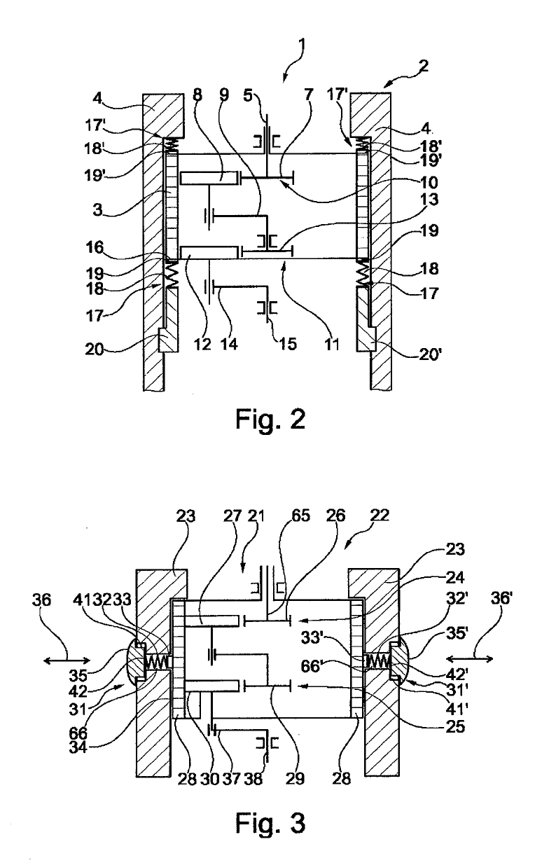

FIG. 2 shows a schematic representation of the part of the gearing 1 of dental instrument 2 designed as planetary gearing shown in FIG. 1. First, as well as second, stages 10, 11 of dental instrument 1 are housed in gearing housing 4. First stage 10 is formed from sun gear 3, planetary gear 8, and ring gear 7, and second stage 11 is formed from sun gear 13, planetary gear 12, and ring gear 7.

The torque-limiting device 17 is arranged on first end 16 of ring gear 7. This torque-limiting device 17 includes spring element 18, as well as washer 19, wherein spring element 18 is affixed to counter-holder 20. Torque-limiting device 17 is located with washer 19 at end 16 of ring gear 7. The torque also changes, depending upon how firmly torque-limiting device 17 is pressed against ring gear 7. If torque-limiting device 17 is removed from ring gear 7, the rotational motion of ring gear 7 is not braked, and no torque can be transmitted, i.e., shaft 15 stops.

Second torque-limiting device 17′, which includes spring element 18 as well as washer 19, is arranged on second end 16′ of ring gear 7 that is located opposite to first end 16, the design of first torque-limiting device 17 corresponding to that of second torque-limiting device 17′.

It is also possible that only one torque-limiting device is provided. In this case, torque-limiting device 17′ and, with it, spring element 18′ may be omitted, so that ring gear 7, which is designed to slip, is held only by torque-limiting device 17. However, this is not shown in FIG. 2.

Different stages 10, 11 in ring gear 7 have the same module. This module (in accordance with DIN 780) can be between 0.1 mm and 0.7 mm, and preferably, between 0.15 mm and 0.3 mm. It is, of course, possible that gearing stages 10, 11 have different modules. If the gearing has only a single stage, this gearing is then preferably designed as an eccentric gearing and has modules (in accordance with DIN 780) that are between 0.1 mm and 0.7 mm, and preferably, between 0.2 and 0.5 mm. The eccentric gearing also has a ring gear. As with the ring gear of the planetary gearing, torque-limiting devices can also be provided on the ring gear of the eccentric gearing that are arranged on at least one end of the ring gear.

FIG. 3 shows a schematic illustration of a first variant 21 of the part of the planetary gearing illustrated in FIG. 1. This planetary gearing 21 is also part of a dental instrument 22, wherein a tool mounted on instrument 22 can be put into motion via planetary gearing 21. The tool can, for example, be an endo file, a drill, or a milling cutter. In FIG. 3, gearing 21 also has more than one stage. It is clear that this gearing can also have only one stage, wherein this gearing is then not designed as a planetary gearing, but, instead, preferably as an eccentric gearing.

Planetary gearing 21 sits in a gearing housing 23 and includes a first stage 24 and a second stage 25. First stage 24 is formed by a sun gear 26 that is arranged on a shaft 65, a planetary gear 27, as well as a ring gear 28. Second stage 25 is formed by a sun gear 29, a planetary gear 30, ring gear 28, a web 37, and a shaft 38. Planetary gearing 21 has additional planetary gears, which are, however, not visible in FIG. 3. Planetary gearing 21 preferably includes two additional planetary gears, whereby planetary gearing 21 contains a total of three planetary gears. It is also conceivable that planetary gearing 21 includes only one planetary gear, or also two or more than three planetary gears. Planetary gearing 21 preferably has a slip ring gear 28 in the event of an overload. In this respect, planetary gearing 21 does not differ from the planetary gearing illustrated in FIG. 2.

In gearing 21 as well, different gearing stages 24, 25 have the same module (in accordance with DIN 780), wherein it is also possible, of course, that the gearing stages have different modules. The modules can assume values from 0.1 mm to 0.7 mm, and preferably, from 0.15 mm to 0.3 mm. If gearing 21 has only one stage, it is then preferably designed as an eccentric gearing and has modules (in accordance with DIN 780) that are between 0.1 mm and 0.7 mm, and preferably, between 0.2 and 0.5 mm.

Ring gear 28 in FIG. 3 is mounted in gearing housing 23 via its outer surface 34, and has play.

A first torque-limiting device 31 can be recognized, as well as an opposing second torque-limiting device 31′, by which the torque of planetary gearing 21 can be controlled. For this purpose, torque-limiting devices 31 and 31′ are designed as adjustable devices and are at least partially arranged in gearing housing 23. First torque-limiting device 31 includes spring element 32 as well as a washer 33, wherein washer 33 can be brought into contact with outer surface 34 of ring gear 28. For this purpose, torque-limiting device 31 has an adjusting element 35 by which torque-limiting device 31 can be moved in the direction toward or away from outer surface 34 of ring gear 28, as indicated by a double arrow 36. Adjusting element 35 is at least partially seated in a circumferential groove 41, which is in an outer side of gearing housing 23. A radially extending bore 66 for receiving spring element 32 connects to this groove 41. Second torque-limiting device 31′ is also designed correspondingly. It also has an adjusting element 35′ that sits at least partially in a circumferential groove 41′, wherein groove 41′ is arranged in the outer side of gearing housing 23. A radially extending bore 66′, into which spring element 32′ is introduced, connects to groove 41′. A washer 33′ is arranged on spring element 32′, wherein washer 33′ can be brought into contact with outer surface 34 of ring gear 28 (double arrow 36′). Spring element 32′ is at least partially seated in bore 66′. Adjusting element 35, 35′ is preferably a set screw, because a set screw is a simple and very inexpensive component.

If torque-limiting device 31 is moved in the direction of outer surface 34 of ring gear 28 via adjusting element 35 so that washer 33 comes into contact with ring gear 28, the rotational movement of ring gear 28 is interrupted. The further it is advanced, the higher is the release torque of gear ring 28. The advantage of this variation is that, by using adjusting elements 35, 35′, the torque of planetary gearing 21 can be very precisely set.

Of course, corresponding washers 33, 33′ can also be omitted from torque-limiting devices 31, 31′. However, washers 33, 33′ prevent spring element 32 or spring element 32′ from damaging ring gear 28, or ring gear 28 from damaging spring element 32 or spring element 32′ if they should come into direct contact with each other.

Both adjusting elements 35, 35′ preferably have an eccentric surface 42, 42′, by means of which corresponding spring elements 32, 32′ are connected. If adjusting elements 35, 35′ are adjusted—for example, by turning these adjusting elements 35, 35′—the pre-stress of spring elements 32, 32′ is changed and, with it, the transmitted torque. Adjusting elements 35, 35′ are preferably simultaneously adjustable, so that the same spring force operates on ring gear 28 from both adjusting elements 35, 35′. As can be seen in FIG. 3, adjusting elements 35, 35′ are accessible from the outside, whereby the torque can be adjusted or changed by a user from the outside. Because two torque-limiting devices 31, 31′ are provided, and the spring elements 32, 32′ of these torque-limiting devices 31, 31′ are additionally symmetrically arranged, ring gear 28 can have a noticeable play.

A person skilled in the art can, of course, also arrange the adjusting elements 35, 35′ in gearing housing 23 in such a manner that they are not accessible from the outside. However, the variant in which adjusting elements 35, 35′ are accessible from the outside and can be easily adjusted by a user is preferred. If the gearing is an eccentric gearing, the torque-limiting devices can also be arranged on the outside of the ring gear of the eccentric gearing. However, this variant is not shown in FIG. 3.

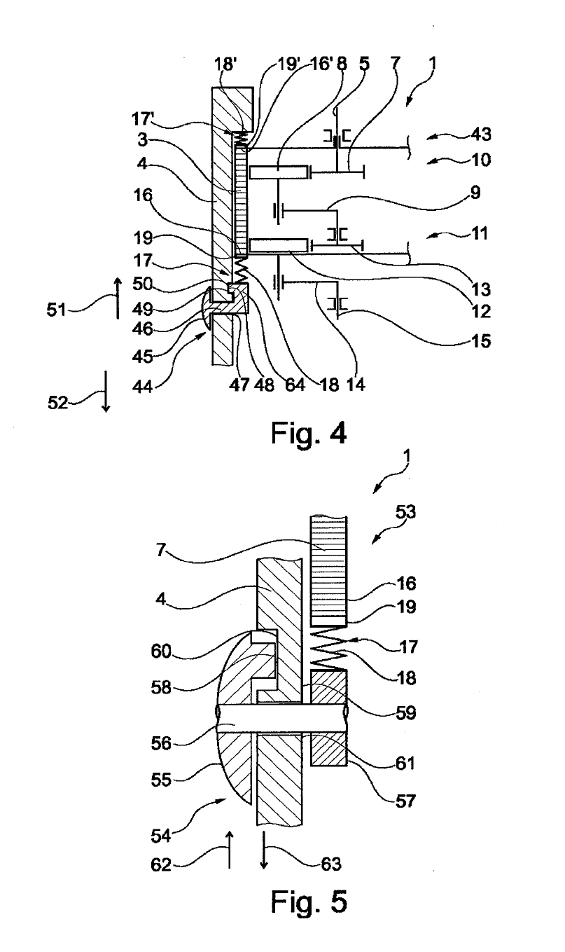

FIG. 4 shows a schematic illustration of a first variant of the part of the gearing illustrated in FIG. 2, wherein only a part of the gearing is illustrated. Gearing 43 according to FIG. 4 is also built into dental instrument 1, and its design essentially corresponds to gearing 1 according to FIG. 2, the reference numbers for the individual components having consequently been retained. Gearing 43 is also housed in gearing housing 4 and contains the first as well as the second gearing stage 10, 11. First stage 10 is formed from sun gear 3, planetary gear 8, and ring gear 7, and second stage 11 is formed from sun gear 13, planetary gear 12, and ring gear 7.

The torque-limiting device 17 is arranged on end 16 of ring gear 7, and torque-limiting device 17′ is arranged on opposing end 16′. The torque-limiting devices 17, 17′ each also have spring element 18 or 18′, as well as washer 19 or 19′. Thus, the design of first torque-limiting device 17 corresponds in turn to the design of the torque-limiting device 17′. Spring elements 18 and 18′ can, for example, be ondular springs, leaf springs, gas springs, or compression springs.

Spring element 18 is affixed to adjusting element 44. Adjusting element 44 is designed as one piece and includes a lever 45 accessible from the outside that is arranged on a connecting means 46—preferably, a pin 46. Connecting means 46 is inserted into a bore 47 made in gearing housing 4. A counter-holder 64 is provided on connecting means 46, on which spring element 18 of torque-limiting device 17 is arranged. Adjusting element 44 has a thread 48 that engages in adjusting thread 49 arranged in groove 50, wherein groove 50 is situated in an inner side of gearing housing 4. In FIG. 4, thread 48 is attached to counter-holder 64. If adjusting element 44 moves in the direction of ring gear 7, i.e., in the direction of arrow 51, then torque-limiting device 17 also moves in the direction of ring gear 7, i.e., in an axial direction. However, if adjusting element 44 moves in the direction of arrow 52, then torque-limiting device 17 moves away from ring gear 7. Through adjustment of adjusting element 44, the spring force of the corresponding spring elements 18, 18′ and, thus, the torque, can be changed.

Gearing 43 thus differs from the gearing according to FIG. 1 only in that, instead of a fixed counter-holder, an adjusting element 44 is provided that moves torque-limiting device 17 and can thus change the torque.

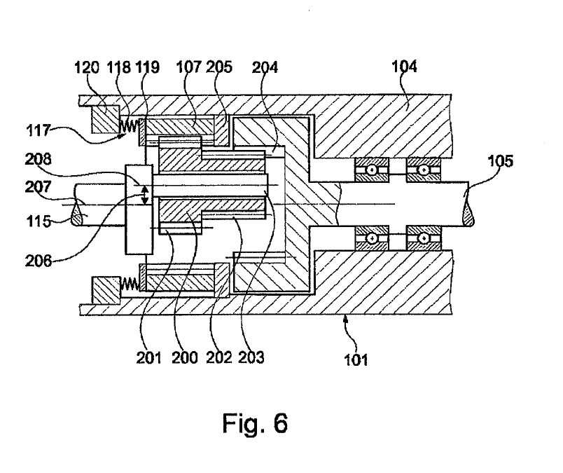

FIG. 5 shows a schematic illustration of a second variant of the part of the gearing illustrated in FIG. 4. This gearing 53 differs from the gearing illustrated in FIG. 4 only in the design of the adjusting element. Gearing 53 thus has an adjusting member 54 that is of a multi-part design. Adjusting element 54 includes a lever 55 that is connected to a counter-holder 57 via a connecting means 56, which is preferably designed as a pin, wherein connecting means 56 is guided through a bore 61 that is made in gearing housing 4. The torque-limiting device 17 consisting of spring element 18 and washer 19 is arranged on lever 55. Adjusting element 54 has a thread 58, which engages in an adjusting thread 59 that is arranged in a groove 60 sitting on an outer side of gearing housing 4. Thread 48 of adjusting element 54 is arranged on lever 55.

The torque can be changed by adjusting the adjusting element 54. If adjusting element 54 moves in the direction of ring gear 7, i.e., in the direction of arrow 62, and thus in an axial direction, then torque-limiting device 17 also moves in the direction of ring gear 7. However, if adjusting element 54 moves in the direction of arrow 63, then torque-limiting device 17 moves away from ring gear 7.

The mode of action of an eccentric gearing arranged in gearing housing 104 and having an integrated torque-limiting device is explained in FIG. 6.

A pin 203 having a central axis 208 is arranged on a drive shaft 115 in such a manner that central axis 208 is at a distance 206 from central axis 207, and pin 203 is, accordingly, arranged eccentrically with respect to central axis 207. Two planetary gears 201 and 202 are arranged on pin 203 as a so-called double wheel 200, and thus so as to be rotationally fixed on each other. The externally-toothed first planetary gear 201 meshes with an internally-toothed first ring gear 107. The externally-toothed second planetary gear 202 meshes with an internally-toothed second ring gear 204.

According to the known prior art, internally-toothed first ring gear 107 would be joined so as to be rotationally fixed to housing 104, and externally-toothed second ring gear 204 would be connected to output shaft 105. If drive shaft 115 is rotated, pin 203 performs an orbital rotation around central axis 207 and thus takes double wheel 200 with it. Because first planetary gear 201 is engaged with internally-toothed first ring gear 107, double wheel 200 performs a rotational movement around its own axis 208 in addition to an orbital rotation around axis 207. First planetary gear 201 is thus supported on internally-toothed first ring gear 107, and reaction forces occur on internally-toothed first ring gear 107. The superimposed orbital-rotational movement of first planetary gear 201 is transferred to second planetary gear 202. Second planetary gear 202 is designed in such a manner that it remains permanently engaged with internally-toothed second ring gear 204 during the orbital-rotational movement of second planetary gear 202 and rotates internally-toothed second ring gear 204. Small differences in the number of teeth between ring gears 107, 204 and planetary gears 201, 202 allow large step-up ratios to be realized in a compact manner. The reaction forces engaging with first ring gear 107 are absorbed by housing 104 in the prior art.

If internally-toothed first ring gear 107, having a torque-limiting device 117, is pre-stressed against a shaped element 205 as a counter-holder working together with housing 104, in the event that a predetermined torque is exceeded, internally-toothed ring gear 107 can slide in relation to housing 104, and thus effect a torque limitation. The torque-limiting device 117 includes a spring element 118 that is supported against a preferably adjustable stop 120 connected to housing 104, and is indirectly located on first ring gear 107, i.e., with the help of a thrust washer 119. Below the maximum torque, first ring gear 107 is affixed in housing 104 by the placement of thrust washer 119 and by shaped element 205; if the maximum torque is exceeded—for example, because output shaft 105, and thus second ring gear 204, is blocked—the first ring gear slips in relation to thrust washer 119 and shaped element 205, and rotates around central axis 207. The rotary motion of first ring gear 107 is created by drive shaft 115 rotating and, with it, pin 203 also rotating eccentrically, and, by this rotation, second planetary gear 202 also starting to rotate within locked second ring gear 204. The rotational direction of double wheel 200 is opposite to the rotational direction of drive shaft 105. The slippage of first ring gear 107 limits the force transmission, and first ring gear 107 rotates in compensation for a speed differential and is driven by first planetary gear 201.

A person skilled in the art can, of course, combine the torque-limiting devices according to FIGS. 2 to 6 in one gearing. Therefore, it is possible, for example, to provide at least one torque-limiting device that is in contact with the outer surface of the ring gear, as well as to arrange the torque-limiting devices that are in contact with the corresponding end of the ring gear in the gearing housing. This allows the torque to be more precisely adjusted, because torque-limiting devices are provided at the ends of the ring gear, as well as on the outer surface of the ring gear.

Although not illustrated in the figures, each of the n stages of the planetary gearing can thus have its own ring gear. One of these ring gears is associated with at least one torque-limiting device so that the torque of this ring gear can be controlled via the at least one corresponding torque-limiting device. The remaining ring gears can be pressed into the gearing housing, whereby they are situated so as to be rotationally fixed in the housing. It is also possible, however, for the remaining ring gears to be arranged loosely in the gearing. A combination of ring gears arranged loosely and so as to be rotationally fixed in the gearing housing is also possible. These ring gears, arranged either so as to be rotationally fixed or loosely in the gearing, do not turn during operation of the instrument. The torque can thus be very precisely adjusted. A plurality of gear ratios can be set as a result.

The modules (in accordance with DIN 780) of individual gearing stages are between 0.1 mm and 0.7 mm, and preferably, between 0.15 mm and 0.3 mm, and, for an eccentric gearing, between 0.2 and 0.5 mm. It is understood that the modules of the stages in the individual ring gears can also vary in size.

1. Dental instrument (2) having a gearing (1, 21, 43, 53; 101) for driving a tool, wherein the gearing (1, 21, 43, 53) is arranged in a gearing housing (4, 23; 104) and wherein the gearing (1, 21, 43, 53; 101) has at least one gearing stage (10, 11, 24, 25), characterized in that this one gearing stage (10, 11, 24, 15) includes at least one ring gear (7, 28) and in that at least one torque-limiting device (17, 17′, 31, 31′; 117) is arranged in the interior of the gearing housing (4), and in that at least one ring gear (7, 28; 107) is loosely mounted in the direction of rotation relative to the housing, and in that the at least one torque-limiting device (17, 17′, 31, 31′; 117) includes a pre-stressed spring element (18, 18′, 32, 32′; 118), which is at least partially in contact with the ring gear (7, 28; 107), and brings it directly or indirectly into contact with the gearing housing (4, 23; 104), wherein the ring gear (7, 28; 107) is designed to limit torque relative to the gearing housing (4, 23; 104) by slipping against the pre-stress.

2. Dental instrument according to claim 1, characterized in that the gearing (101) has a single gearing stage, wherein the gearing (101) is an eccentric gear, and the ring gear (107) is part of the eccentric gear.

3. Dental instrument according to claim 1, characterized in that the gearing (1, 21, 43, 53) has two or more gearing stages and is a planetary gear (1, 21, 43, 53), wherein the planetary gear (1, 21, 43, 53) has at least the one slip ring gear (7, 28), wherein each of the at least two gearing stages (10, 11, 24, 25) includes at least one planetary gear (8, 12, 27, 30) that is arranged between a sun gear (3, 13, 26, 29) and the ring gear (7, 28), and wherein the ring gear (7, 28) is in contact with the at least one torque-limiting device (17, 17′, 31, 31′).

4. Dental instrument according to one of claims 1 through 3, characterized in that there are provided additional ring gears, in each of which is provided at least an additional gearing stage, wherein these additional ring gears are incorporated either so as to be rotationally fixed or loosely into the gearing housing (4, 23; 104).

5. Dental instrument according to one of claims 1 through 4, characterized in that each gearing stage (10, 11, 24, 25) has a module that is between 0.1 mm and 0.7 mm, and preferably between 0.15 mm and 0.3 mm, and, for an eccentric gear, preferably between 0.2 and 0.5 mm.

6. Dental instrument according to one of claims 1 through 5, characterized in that a second torque-limiting device (17′) is provided that is arranged in the interior of the gearing housing (4), wherein the spring element (18′) can at least partially be brought into contact with an end (16′) opposite the first end (16) of the ring gear (7).

7. Dental instrument according to one of claims 1 through 6, characterized in that a counter-holder (20; 205) fixedly arranged in the gearing housing (4) is provided, and that the spring element (18; 118) of the torque-limiting device (17; 117) is arranged between the end (16) of the ring gear (7; 107) and the counter-holder (20; 205).

8. Dental instrument according to one of claims 1 through 7, characterized in that there is provided a counter-holder (57, 64), onto which the spring element (18) of the torque-limiting device (17) is introduced in such a manner that the spring element (18) is arranged between the end (16) of the ring gear (7) and the counter-holder (57, 64), wherein the counter-holder (57, 64) is arranged in the gearing housing (4) and is part of an adjusting element (44, 54), by which the pre-stress—and with it the spring force of the spring element (18) and, thus, the torque—can be changed.

9. Dental instrument according to claim 8, characterized in that the adjusting element (44, 54) has a lever (45, 55) that is arranged outside the gearing housing (4) and is connected to the counter-holder (57, 64) via a connecting means (46, 56).

10. Dental instrument according to claim 9, characterized in that the gearing housing (4) has a bore (47, 61) into which the connecting means (46, 56) is introduced.

11. Dental instrument according to one of claims 8 through 10, characterized in that the adjusting element (44, 54) has a thread (48, 58) that is connected to an adjustment thread (49, 59), wherein the adjusting thread (49, 59) is seated in a groove (49, 60) arranged in the gearing housing (4).

12. Dental instrument according to one of claims 1 through 11, characterized in that the at least one torque-limiting device (31, 31′) is connected via the spring element (32, 32′) to an adjusting element (35, 35′), wherein the adjusting element (35, 35′) is at least partially seated into a circumferential groove (41, 41′), wherein the groove (41, 41′) is made on an outer side of the gearing housing (23).

13. Dental instrument according to claim 12, characterized in that a radially extending bore (66, 66′) connects to the groove (41, 41′) in which the spring element (32, 32′) is arranged in such a manner that the spring element (32, 32′) is in contact with an outer surface (34) of the ring gear (28).

14. Dental instrument according to claim 12, characterized in that the adjusting element (35, 35′) is a set screw.

15. Dental instrument according to one of claims 1 through 14, characterized in that a washer (19; 119) is arranged on the spring element (18, 18′, 32, 32′; 118), wherein the washer (19; 119) is arranged between the spring element (18, 18′, 32, 32′; 118) and the ring gear (7; 107), so that the washer (19; 119) is in contact with the ring gear (7, 28; 107).

16. Dental instrument according to one of claims 1 through 15, characterized in that at least one torque-limiting device (31, 31′) is provided that is in contact with the outer surface (34) of the ring gear (7, 28), and at least one additional torque-limiting device (17, 17′) is provided that is in contact with one end (16, 16′) of the ring gear (7, 28).
